(19) United States
(12) Patent Application Publication
(10) Pub. No.: US 2024/0215600 A1
(43) Pub. Date: Jul. 4, 2024

(54) A PUMPABLE FAT SYSTEM AND PROCESS FOR TRANSPORTING THEREOF

(71) Applicant: CARGILL, INCORPORATED, Wayzata, MN (US)

(72) Inventor: Bassam JIRJIS, Plymouth, MN (US)

(21) Appl. No.: 18/556,776

(22) PCT Filed: Apr. 13, 2022
(86) PCT No.: PCT/US2022/024579

§ 371 Date: Oct. 23, 2023

Related U.S. Application Data
(60) Provisional application No. 63/178,662, filed on Apr. 23, 2021.

(51) Int. Cl. A23D 9/04

(52) U.S. Cl. CPC A23D 9/04

(57) ABSTRACT

The present technology provides a pumpable fat system that includes about 1.0 weight percent (“wt %”) to 100 wt % of a first fat component that includes a percent solids content of at least 1.0 wt %, based on total weight of the pumpable fat system; and optionally, a second fat component; wherein the pumpable fat system has the following properties at a temperature of about 60° F. to about 85° F.: a percent solids content of about 1% to about 20% based on total weight of the pumpable fat system; a viscosity of up to about 2,000,000 cP; and a texture of 500 G force/cm or less. The present technology also includes compositions and food items containing the pumpable fat system and methods of supplying the pumpable fat system.

### CROSS-REFERENCE TO RELATED APPLICATIONS

This application claims the benefit of U.S. Provisional Patent Application No. 63/178,662, filed Apr. 23, 2021, which is incorporated by reference herein in its entirety.

### TECHNICAL FIELD

This application relates to pumpable shortenings, compositions and food items containing the pumpable shortening, and methods of supplying thereof.

### BACKGROUND

Shortenings are tailored fat systems whose nutritional and functional properties have been manipulated in order to deliver specific consumer needs. Shortenings offer special functional utility to baking applications. Shortenings may be prepared using processes known in the art, such as votation. Votation refers to a controlled process in which a molten fat or blend of fats is crystallized and homogenized to form a shortening or other tailored fat system. The term votation comes from Votator™, which is the name of early equipment used for manufacturing shortenings used in baking and other food applications.

Currently, such shortenings are loaded into boxes and tempered in a temperature-controlled room for specified times before shipping to customers. Once received, customers typically store the shortening in temperature-controlled rooms prior to use. However, shortenings produced in this form are typically hard and are not pumpable. Additionally, removing these shortenings from boxes or other storage containers and loading them into customer applications involves labor and time intensive processes. Additionally, handling and unloading such shortenings from storage containers into customer applications can be ergonomically unsafe for personnel.

The present technology is directed to overcoming these and other deficiencies in use, handling, and supplying a pumpable shortening.

### SUMMARY

In one aspect, the present technology provides a pumpable fat system that includes at least about 1.0 weight percent (“wt %”) to 100 wt % of a first fat component having a solid fat content (“SFC”) of at least about 1.0 wt %, based on total weight of the pumpable fat system; and optionally, a second fat component. The pumpable fat system has the following properties at a temperature of about 60° F. (˜15.6° C.) to about 85° F. (˜29.4° C.): a SFC of about 1.0 wt % to about 20 wt % based on total weight of the pumpable fat system; a viscosity of up to about 2,000,000 cP; and a texture of 500 G force/cm or less.

In an aspect, the present technology provides a composition that includes about 0.1 wt % to about 100 wt % of a pumpable fat system as described herein.

In an aspect, the present technology provides a food item that includes the pumpable fat system as described herein.

In another aspect, the present technology provides a method of supplying the pumpable fat system as described herein. The method includes:
loading the pumpable fat system into a container;
transporting the container containing the pumpable fat system; and
removing the pumpable fat system from the container;
wherein the pumpable fat system is maintained at a constant temperature of about 60° F. (˜15.6° C.) to about 85° F. (˜29.4° C.).

### DETAILED DESCRIPTION

Reference will now be made in detail to certain aspects of the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. As will be understood by one skilled in the art, all language such as “up to,” “at least,” “greater than,” “less than,” and the like, include the number recited and refer to ranges which can be subsequently broken down into subranges as discussed above. Finally, as will be understood by one skilled in art, a range includes each individual member.

As used herein, the singular forms “a,” “an,” and “the” and similar referents in the context of describing the elements (especially in the context of the following claims) include plural referents unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Any publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure, and are not meant to be limiting in any fashion.

In the methods described herein, the acts can be carried out in a specific order as recited herein. Alternatively, in any aspect(s) disclosed herein, specific acts may be carried out any order without departing from the principles of the disclosure, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The term “substantially” as used herein refers to a majority of, or mostly, as in at least about 85%.

As used herein, the following terms have the following meanings unless expressly stated to the contrary.

A “triacylglyceride” refers to a molecule having a glycerol moiety that is linked to three fatty acid residues via ester bonds. The terms “triacylglycerol,” “triacylglyceride,” “triglyceride,” and “TAG” are used interchangeably herein.

The term “fatty acid” as used herein can refer to a molecule comprising a hydrocarbon chain and a terminal carboxylic acid group. As used herein, the carboxylic acid group of the fatty acid may be modified or esterified, for example as occurs when the fatty acid is incorporated into a glyceride or another molecule (e.g., COOR, where R refers to, for example, a carbon atom). Alternatively, the carboxylic acid group may be in the free fatty acid or salt form (i.e., COO″ or COOH). The ‘tail’ or hydrocarbon chain of a fatty acid may also be referred to as a fatty acid chain, fatty acid sidechain, or fatty chain. The hydrocarbon chain of a fatty acid will typically be a saturated or unsaturated aliphatic group. A fatty acid having N number of carbons, will typically have a fatty acid side chain having N−1 carbons. However, the subject application also relates to modified forms of fatty acids, e.g., epoxidized fatty acids, and thus the term fatty acid may be used in a context in which the fatty acid has been substituted or otherwise modified as described.

A “fatty acid residue” is a fatty acid in its acyl or esterified form.

A “saturated” fatty acid is a fatty acid that does not contain any carbon-carbon double bonds in the hydrocarbon chain. An “unsaturated” fatty acid contains one or more carbon-carbon double bonds. A “polyunsaturated” fatty acid contains more than one such carbon-carbon double bond while a “monounsaturated” fatty acid contains only one carbon-carbon double bond. Carbon-carbon double bonds may be in one of two stereoconfiguration denoted cis and trans. Naturally occurring unsaturated fatty acids are generally in the “cis” form. Epoxidized renewable oil or fat may include one or more epoxide rings formed from cis or trans carbon-carbon double bonds.

Non-limiting examples of fatty acids include C8, C10, C12, C14, C16 (e.g., C16:0, C16:1), C18 (e.g., C18:0, C18:1, C18:2, C18:3, C18:4), C20 and C22 fatty acids. For example, the fatty acids can be caprylic (8:0), capric (10:0), lauric (12:0), myristic (14:0), palmitic (16:0), stearic (18:0), oleic (18:1), linoleic (18:2) and linolenic (18:3) acids.

As used herein, the term “pumpable fat system” refers to a tailored fat system (e.g., shortening) that may be handled in bulk quantities and can be pumped and metered.

The present technology provides a pumpable fat system that includes an edible fat and optionally an edible oil, compositions and food items containing the pumpable fat system, and methods of supplying the pumpable fat. As would be understood by persons of ordinary skill in the art, fat systems such as shortenings and the like may be prepared via votation. The pumpable fat system as described herein may be prepared via votation. Generally, votation processes for making a shortening includes: melting an edible fat to form the molten fat and agitating the molten fat at a constant temperature above its melt point; pumping the molten fat through one or more scrape surface crystallizers to crystalize the molten fat; and passing the molten fat through one or more worker units having a set of fixed and a set of rotating fingers across a shaft, which results in break-up of the crystals in the product temperature to indicate crystallization of the fat product (i.e., the shortening).

The inventors discovered that the pumpable fat system as described herein advantageously enhances the ability to supply and incorporate the pumpable fat system into customer applications. In particular, the inventors discovered the pumpable fat system advantageously eliminates the need to mix, store, and temper the pumpable fat system (either by the supplier or customer), eliminates the need to package the product (e.g., in bagged boxes), eliminates labor intensive processes to unload the pumpable fat system from containers and/or load into customer applications, allows for automation and tracking of pumpable fat systems directly from transport containers into customer applications, reduces waste disposal, provides ergonomically safer processes for handling of shortenings, and/or otherwise enhances incorporation of shortening into a customer application (such as food manufacturing systems).

### Pumpable Fat System

In one aspect, the present technology provides a pumpable fat system that includes at least about 1.0 weight percent (“wt %”) to 100 wt % of a first fat component having a solid fat content (“SFC”) of at least about 1.0 wt % at room temperature (i.e., approximately about 20° C. to about 25° C.), based on total weight of the pumpable fat system; and optionally, a second fat component. The pumpable fat system has the following properties at a temperature of about 60° F. (˜15.6° C.) to about 85° F. (˜29.4° C.): a SFC of about 1.0 wt % to about 20 wt % based on total weight of the pumpable fat system; a viscosity of up to about 2,000,000 cP; and a texture of 500 G force/cm or less.

The first fat component of the pumpable fat system includes an edible solid fat having a crystalized solid fat content (or SFC) of at least 1.0 wt % at room temperature (i.e., approximately about 20° C. to about 25° C.). As used herein, the term “solid fat” or “solid fat content” refers to the percent of crystalized solid fat present over a defined temperature scale. SFC may be measured by methods known to persons of ordinary skill in the art; for example, the SFC may be determined via nuclear magnetic resonance (NMR) (See AMERICAN OIL CHEMIST SOCIETY Official Methods and Recommended Practices, 6^{th} ed., 2008, AOCS Official Method cd-16b-93, which is incorporated herein by reference). The first fat component may be an edible solid fat or an edible liquid fat having the at least 1.0 wt % SFC at room temperature. Preferably, the first fat component has a SFC of greater than about 1.0 wt %, greater than about 5 wt %, greater than about 10 wt %, greater than about 20 wt %, or greater than about 25 wt % at room temperature.

As used herein, the terms “edible solid fat”, “edible liquid fat”, or “edible oil” refer to a fat or oil that is suitable for human consumption. Edible solid fats, edible liquid fats, and edible oils are typically compositions including triacylglycerols (“TAG”). The edible solid fats, edible liquid fats, and edible oils may be obtained from plant, animal, or microbial sources.

Generally, the first fat component is an edible solid fat that is in a solid or semi-solid state at room temperature (i.e., approximately about 20° C. to about 25° C.) and ambient pressure (i.e., approximately 1 atm) having a SFC of at least about 1.0 wt %, an edible liquid fat that is in a liquid or semi-liquid state at room temperature and ambient pressure having a SFC of at least about 1.0 wt %, or mixtures thereof. Edible solid or liquid fats, as described herein, may be natural fats (i.e., unmodified), modified fats, or mixtures thereof. For example, the modified fat may be a hydrogenated fat, a chemically or enzymatically interesterified fat, a fractionated fat, or mixtures thereof.

Suitable edible solid and/or liquid fats may include, but are not limited to, butter, lard, tallow, butter oil, cocoa butter, mango butter, shea butter, milk fat, coconut oil, palm oil, palm olein, palm kernel oil, shea oil, illipe oil, sal oil, kokum gurgi oil, mango kernel oil, hydrogenated vegetable oil (such as hydrogenated fractionated palm kernel oil, hydrogenated cottonseed oil, hydrogenated soybean oil, hydrogenated sunflower oil, hydrogenated canola oil, hydrogenated rapeseed oil, and the like or mixtures thereof), hydrogenated fish oil, or mixtures of two or more thereof. As used herein, “vegetable oils” refers to oils derived from vegetables and/or oil seeds. Typically, the edible solid and/or liquid fat may be stearin (such as palm stearin, cottonseed stearin, cocoa butter stearin, shea stearin, palm kernel stearin, sunflower stearin), hydrogenated vegetable oil, palm oil, interesterified palm oil, or mixtures of two or more thereof. Preferably, the edible solid and/or liquid fat may be selected from palm stearin, palm oil, interesterified palm oil, hydrogenated soybean oil, or mixtures of two or more thereof.

The pumpable fat system may include about 10 wt % to 100 wt % of the first fat component based on total weight of the pumpable fat system. For example, the pumpable fat system may include about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 99 wt %, 100 wt %, or any range including and/or in between any two of the preceding values. Typically, the pumpable fat system may include the first fat component in amounts of about 10 wt % to 100 wt %, about 30 wt % to about 95 wt %, about 60 wt % to about 90 wt %, or about 70 wt % to about 85 wt %.

The pumpable fat system may further include a second fat component. The second fat component may be any suitable edible fat or oil. Generally, the second fat component is different from first fat component. For example, the second fat component may be an edible oil that is free, or substantially free, of crystallized solid fat at room temperature (i.e., about 20° C. to about 25° C.) and ambient pressure (i.e., about 1 atm). As used herein, the term “substantially free of crystallized solid fat” means the edible fat or oil has an SFC that is less than 1.0 wt %, is less than about 0.5 wt %, is less than 0.1 wt %, or is 0 wt % at room temperature and ambient pressure. Preferably, the second fat component is an edible oil.

Edible oils are typically in a liquid state at room temperature (i.e., approximately about 20° C. to about 25° C.) and ambient pressure (i.e., approximately 1 atm), and are free, or substantially free, of crystallized solid fat. The edible oils, as described herein, may be natural oils (i.e., unmodified), modified oils, or mixtures thereof. For example, the edible oil may be a hydrogenated oil, a chemically or enzymatically interesterified oil, a fractionated oil, or mixtures thereof. The edible oil may include, but is not limited to, sunflower oil, citrus oil (such as lemon oil, orange oil, and the like or mixtures thereof), grape seed oil, sesame oil, peanut oil, mustard oil, nut oil (such as almond oil, cashew oil, walnut oil, hazelnut oil, macadamia oil, or mixtures thereof), corn oil, wheat kernel oil, rapeseed oil, safflower oil, flaxseed oil, soybean oil, canola oil, cottonseed oil, marine oil (such as fish oil, algal oil, fungal oil, or mixtures thereof), rice bran oil, olive oil, or mixtures of two or more thereof. The edible oil may be a high oleic edible oil, such as high oleic sunflower oil, high oleic citrus oil, high oleic grape seed oil, high oleic sesame oil, high oleic peanut oil, high oleic mustard oil, high oleic nut oil, high oleic corn oil, high oleic wheat kernel oil, high oleic rapeseed oil, high oleic safflower oil, high oleic flaxseed oil, high oleic soybean oil, high oleic canola oil, high oleic cottonseed oil, high oleic marine oil, or mixtures of two or more thereof. Preferably, the edible oil is soybean oil, canola oil, or mixtures of two or more thereof.

The pumpable fat system may include the second fat component in an amount of 0 wt % to about 90 wt %, about 0.1 wt % to about 90 wt %, about 5 wt % to about 50 wt %, about 10 wt % to about 35 wt %, or about 15 wt % to about 30 wt %, based on total weight of the pumpable fat system. Suitable amounts of the second fat component may include about 0.1 wt %, about 0.5 wt %, about 1 wt %, about 5 wt %, about 10 wt %, about 15 wt % about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, or any range including and/or in between any two of the preceding values.

The pumpable fat system may further include one or more additives. Such additives include emulsifiers, antioxidants, or mixtures thereof. Suitable emulsifiers may include, but are not limited to, monoglycerides and/or diglycerides (such as distilled mono- and diglycerides from palm oil, soybean oil, or other edible fats or oils, acetylated mono-/di-glycerides, lactylated mono-/di-glycerides, or mixtures thereof), polysorbate, sorbitol, glycerine, soy lecithin, egg yolk lecithin, polyglycerol ester, sorbitan ester, propylene glycol ester, sugar ester, or mixtures of two or more thereof. The pumpable fat system may include emulsifiers in amounts of 0 wt % to about 2.0 wt % based on total weight of the pumpable fat system. For example, the pumpable fat system may include about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, or any range including and/or in between any two of the preceding values. Preferably, the emulsifier is present in an amount of about 0.1 wt % to about 1.5 wt %, about 0.1 wt % to about 1.0 wt %, or about 0.2 wt % to about 0.6 wt %. Any antioxidant suitable for use in edible fats and oils may be used in the pumpable fat system. For example, suitable antioxidants may include, but are not limited to, rosemary extract, tocopherols, and the like or mixtures thereof.

The pumpable fat system as described herein has physical properties (including, but not limited to, solid fat content, viscosity, texture, and the like, or mixtures thereof) at a temperature of about 60° F. (˜15.6° C.) to about 85° F. (˜29.4° C.). Suitable temperatures may include about 60° F. (˜15.6° C.), about 61° F. (˜16.1° C.), about 62° F. (˜16.7° C.), about 63° F. (˜17.2° C.), about 64° F. (˜17.8° C.), about 65° F. (˜18.3° C.), about 66° F. (˜18.9° C.), about 67° F. (˜19.4° C.), about 68° F. (20° C.), about 69° F. (˜20.6° C.), about 70° F. (˜21.1° C.), about 71° F. (˜21.7° C.), about 72° F. (˜22.2° C.), about 73° F. (˜22.8° C.), about 74° F. (˜23.3° C.), about 75° F. (˜23.9° C.), about 76° F. (˜24.4° C.), about 77° F. (25° C.), about 78° F. (˜25.6° C.), about 79° F. (˜26.1° C.), about 80° F. (˜26.7° C.), about 81° F. (˜27.2° C.), about 82° F. (˜87.8° C.), about 83° F. (˜28.3° C.), about 84° F. (˜28.9° C.), about 85° F. (˜29.4° C.), or any range including and/or in between any two of the preceding values. Typically, the temperature may be about 60° F. (˜15.6° C.) to about 85° F. (˜29.4° C.), about 70° F. (˜21.1° C.) to about 85° F. (˜29.4° C.), or about 75° F. (˜23.9° C.) to about 85° F. (˜29.4° C.).

The pumpable fat system may have a SFC of about 1 wt % to about 20 wt % at a temperature of about 60° F. (˜15.6° C.) to about 85° F. (˜29.4° C.). For example, at a temperature of about 60° F. (˜15.6° C.) to about 85° F. (˜29.4° C.) the pumpable fat system may have a SFC of about 1 wt % to about 20 wt %, about 5 wt % to about 18 wt %, or about 7 wt % to about 16 wt %. Suitable SFC values at temperatures of about 60° F. (˜15.6° C.) to about 85° F. (˜29.4° C.) may be about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, or any range including and/or in between any two of the preceding values.

The pumpable fat system may have a viscosity of up to about 2,000,000 cP at a temperature of about 60° F. (˜15.6° C.) to about 85° F. (˜29.4° C.). Viscosity may be measured according to methods known to those of skill in the art. For example, viscosity is measured by Brookfield rheometer with helipath spindle (T-Spindle: 95 & speed of 5 rpm). Suitable viscosity ranges at temperatures of about 60° F. (˜15.6° C.) to about 85° F. (˜29.4° C.) may include about 100,000 cP to less than about 2,000,000 cP, about 200,000 cP to about 1,500,000 cP, about 350,000 cP to about 750,000 cP, about 400,000 cP to about 700,000 cP, or any range including and/or in between any two of these values. For example, the pumpable fat system may have a viscosity of about 100,000 cP, about 150,000 cP, about 200,000 cP, about 250,000 cP, about 300,000 cP, about 350,000 cP, about 400,000 cP, about 500,000 cP, about 550,000 cP, about 600,000 cP, about 650,000 cP, about 700,000 cP, about 750,000 cP, about 800,000 cP, about 850,000 cP, about 900,000 cP, 950,000 cP, about 1,000,000 cP, about 1,100,000 cP, about 1,200,000 cP, about 1,300,000 cP, about 1,400,000 cP, about 1,500,000 cP, about 1,600,000 cP, about 1,700,000 cP, about 1,800,000 cP, about 1,900,000 cP, about 2,000,000 cP, or any range including and/or in between any two of the preceding values.

The pumpable fat system may have a texture of about 500 G force/cm or less at a temperature of about 60° F. (˜15.6° C.) to about 85° F. (˜29.4° C.). Suitable texture values at temperatures of about 60° F. (˜15.6° C.) to about 85° F. (˜29.4° C.) may be 0 G force/cm to less than about 500 G force/cm, 0 G force/cm to about 100 G force/cm, 0 G force/cm to about 125 G force/cm, about 90 G force/cm to about 325 G force/cm, about 100 G force/cm to about 300 G force/cm, about 180 G force/cm to about 425 G, about 200 G force/cm to about 400 G force/cm, or any range including and/or in between any two of the preceding values. As used herein, the term “texture” refers to the softness of the pumpable fat system. Texture may be measured by stable micro system tensile tester instrument (e.g., TAXT2 Plus Texture Analyser) equipped with 5 kg load cell and ½ inch diameter probe.

The pumpable fat system as described herein may further include fat crystals having an average particle size of about 3 μm to about 100 μm—for example, about 20 μm to about 80 μm. Crystal size may be measured by X-ray diffraction (XRD). Suitable particle sizes may include about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, or any range including and/or in between any two of the preceding values.

### Compositions and Food Items

In an aspect, the present technology provides a composition that includes about 0.1 wt % to about 100 wt % of a pumpable fat system as described herein. The composition may be a blend of the pumpable fat system and one or more additional tailored fat systems (e.g., shortenings, lard, tallow, ghee, margarine, butter, table spreads, low-fat or dietary table products, and the like, or mixtures of two or more thereof). The one or more additional tailored fat systems may be present in the composition in amounts of 0 wt % to about 99 wt % based on total weight of the composition. For example, the composition may include the one or more additional tailored fat systems in amounts of about 0 wt % to about 99 wt %, about 1 wt % to about 90 wt %, about 10 wt % to about 80 wt %, about 30 wt % to about 60 wt %, or any range including and/or in between any two of the preceding values.

In an aspect, the present technology provides a food item that includes the pumpable fat system as described herein. The food item may be any suitable food item that includes the pumpable fat system. For example, the food item may include, but is not limited to, a fried food item (e.g., a potato chip, a French fry, a fried-chicken product, a tempura product), a bakery food item, a biscuit filling, an icing, a frosting, a Bakers' confectionary item (e.g., pastries, cakes, cookies, donuts, and the like), a sugar confectionery item (e.g., candies, chocolates, and the like), a biscuit filling, a frosting, or a combination thereof. The food item may include a pie, a biscuit, a pie, a wafer, a filling, a dough, a glaze, a pizza crust, crackers, bread, tortilla, an American biscuit, a chewing gum, a meat alternative, a dairy analog product (e.g., a non-dairy or reduced-dairy substitute product for a dairy product), or a combination thereof.

The present technology provides a use of the pumpable fat system as described herein. The use may include partially or completely replacing a fat in a food item, such as any food item described herein. The use can be to form a food item.

### Method of Supplying the Pumpable Fat System

In another aspect, the present technology provides a method of supplying the pumpable fat system as described herein. The method includes:
loading the pumpable fat system into a container;
transporting the container containing the pumpable fat system; and
removing the pumpable fat system from the container;
wherein the pumpable fat system is maintained at a constant temperature of about 60° F. (˜15.6° C.) to about 85° F. (˜29.4° C.).

The method may include maintaining the pumpable fat system at a constant temperature of about 60° F. (˜15.6° C.) to about 85° F. (˜29.4° C.). Suitable temperatures may include about 60° F. (˜15.6° C.), about 61° F. (˜16.1° C.), about 62° F. (˜16.7° C.), about 63° F. (˜17.2° C.), about 64° F. (˜17.8° C.), about 65° F. (˜18.3° C.), about 66° F. (˜18.9° C.), about 67° F. (˜19.4° C.), about 68° F. (20° C.), about 69° F. (˜20.6° C.), about 70° F. (˜21.1° C.), about 71° F. (˜21.7° C.), about 72° F. (˜22.2° C.), about 73° F. (˜22.8° C.), about 74° F. (˜23.3° C.), about 75° F. (˜23.9° C.), about 76° F. (˜24.4° C.), about 77° F. (25° C.), about 78° F. (˜25.6° C.), about 79° F. (˜26.1° C.), about 80° F. (˜26.7° C.), about 81° F. (˜27.2° C.), about 82° F. (˜87.8° C.), about 83° F. (˜28.3° C.), about 84° F. (˜28.9° C.), about 85° F. (˜29.4° C.), or any range including and/or in between any two of the preceding values. Typically, the temperature may be about 60° F. (˜15.6° C.) to about 85° F. (˜29.4° C.), about 70° F. (˜21.1° C.) to about 85° F. (˜29.4° C.), or about 75° F. (˜23.9° C.) to about 85° F. (˜29.4° C.).

The container may be a pail, a drum, a tote, a piston tanker, and the like or combinations thereof. For example, the container may be a pail, a drum, a tote, or combinations thereof. Generally, the pail, drum, and/or tote may have a capacity sufficient for transporting volumes of the pumpable fat system for use in commercial preparation of products (e.g., food items as described herein). Preferably, the container may be an about 1 gallon (˜3.8 L) to about 13 gallon (˜49 L) pail, an about 55 gallon (˜208 L) drum, an about 275 gallon (˜1041 L) to about 330 gallon (˜1249 L) tote, an about 20,000 L tank or tanker (e.g., piston tanker), or combinations thereof.

The present method advantageously eliminates the need for packaging the pumpable fat system in bagged boxes or storing in a temperature-controlled room. For example, the pumpable fat system may be loaded into a piston tanker (or piston tank). As used herein, the terms “piston tanker” or “piston tank” are used interchangeably. Generally, the term “piston tanker” as described herein refers to a mobile piston tank container (e.g., tanker truck), where the term “piston tank” refers to a stationary piston tank container. A piston tanker (or piston tank) is a tanker truck (or stationary tank) having an internal piston running its length and used as containers for transporting highly viscous bulk material. Loading the piston tanker (or piston tank) with viscous bulk material pushes the piston from the back to the front as the tanker fills. Unloading viscous bulk material is effectuated by applying air pressure to the piston that travels the length of the cylinder to force the bulk material out. The piston tanker (or piston tank) may be equipped to maintain the pumpable fat system at a temperature of about 60° F. (˜15.6° C.) to about 85° F. (˜29.4° C.). The pumpable fat system may be immediately transported to a customer for use and removed for incorporation into the customer's desired application (e.g., food item production) without the need for storing.

The method may further include storing the pumpable fat system in the container. The storing may occur over a period of about 1 h to about 2 weeks. For example, the pumpable fat system may be stored over a period of about 1 h, about 6 h, about 12 h, about 18 h, about 1 day, about 2 days, about 3 days, about 4 days, about 5 days, about 6 days, about 1 week, about 1.5 weeks, about 2 weeks, about 4 weeks, or any range including and/or in between any two of the preceding values. Generally, the storing occurs at a temperature of about 60° F. (˜15.6° C.) to about 85° F. (˜29.4° C.), about 70° F. (˜21.1° C.) to about 85° F. (˜29.4° C.), or about 75° F. (˜23.9° C.) to about 85° F. (˜29.4° C.).

The container may be stored in a temperature-controlled environment (e.g., a temperature-controlled room or facility) such that the pumpable fat system is maintained at a temperature of about 60° F. (˜15.6° C.) to about 85° F. (˜29.4° C.). The container may be a temperature-controlled container, such as a well-insulated temperature-controlled container to maintain product temperature during transport and storage before use. For example, the temperature-controlled container may be a container equipped to maintain the contents therein within a designated temperature. A temperature-controlled container in keeping with the method described herein is a container equipped to maintain the pumpable fat system at a temperature of about 60° F. (˜15.6° C.) to about 85° F. (˜29.4° C.).

The loading may include transferring the pumpable fat system from a feed source through a temperature-controlled conduit to the container. The feed source may be any repository of the pumpable fat system (i.e., the feed). For example, the pumpable fat system may be dispensed from a production apparatus for producing the pumpable fat system (such as a votation system) through the temperature-controlled conduit connected to the production apparatus and into the container. The term “connected,” and the like, as used herein means the joining of two components directly or indirectly to one another. Such joining may be stationary (e.g., permanent or in-line with a manufacturing apparatus) or moveable (e.g., removable or releasable). Such joining may be achieved with the two components or the two components and any additional intermediate components being integrally formed as a single unitary body with one another or with the two components or the two components and any additional intermediate components being attached to one another. Typically, the production apparatus can be a votation system. In any aspect, the loading may further include one or more pumps to feed the pumpable fat system into the container. For example, the one or more pumps may include, but are not limited to, a high pressure pump, a lobe pump, a piston pump, gear pump, Moyno pump, auger pump, and the like or combinations thereof. Additionally or alternatively, the one or more pumps may be part of the production apparatus (e.g., votation system).

The pumpable fat system may have a temperature below the about 60° F. (˜15.6° C.) to about 85° F. (˜29.4° C.) range prior to loading. In such instances, the method may further include heating the pumpable fat system to a temperature of about 60° F. (˜15.6° C.) to about 85° F. (˜29.4° C.) range prior to transferring the pumpable fat system from the feed source through the temperature-controlled conduit.

The temperature-controlled conduit may be a conduit equipped to maintain the pumpable fat system at a temperature of about 60° F. (˜15.6° C.) to about 85° F. (˜29.4° C.). For example, the temperature-controlled conduit may be a water jacketed pipe, wherein heated water is used to maintain the temperature of the pumpable fat system at about 60° F. (˜15.6° C.) to about 85° F. (˜29.4° C.).

During loading, the temperature-controlled conduit may be connected to a feed port (or other suitable inlet) on the container such that the pumpable fat system can be transferred (e.g., pumped) into the container. For example, the temperature-controlled conduit may be connected to a feed port on the piston tanker (or piston tank) to fill the piston tanker (or piston tank) with the pumpable fat system. The temperature-controlled conduit may be fluidly connected to or in fluid communication with the container. As used herein, the terms “fluidly connected,” “in fluid communication,” and the like mean the two components or objects have a pathway formed between the two components or objects in which a fluid, such as the pumpable fat system, water, air, etc., may be supplied, either with or without intervening components or objects.

The method may further include recycling residual amounts of the pumpable fat system back to the feed source. For instance, unused amounts of the pumpable fat system remaining in the temperature-controlled conduit line may be transferred (e.g., via pumping or purging with an inert gas) back to the feed source.

Any suitable means may be used to remove the pumpable fat system from the container. As described herein, the pumpable fat system of the present method advantageously eliminates labor intensive processes for removing tailored shortenings (such as non-pumpable fat systems) from a container into consumer applications, reduces waste disposal, improves handling, and improves incorporation into food item production processes. For example, the pumpable fat system may be removed from the container via a pump. While any pump suitable for pumping viscous bulk materials may be used in the present method, suitable pumps may include, but are not limited to, a lobe pump, a piston pump, gear pump, Moyno pump, auger pump, and the like or combinations thereof.

The pumpable fat system may be removed from the container directly into a customer application, such as a food item production system. The pumpable fat system may be removed from the container to a receiving vessel (e.g., feed tank, kettle, and the like) or inlet conduit (e.g., pipe) of a product manufacturing system. For instance, removing the pumpable fat system may include transferring via a loading system into a customer's application. Such loading systems may include a pump as described herein for pumping the pumpable fat system out of the container. The loading system may further be equipped with a temperature-controlled conduit (e.g., a water jacketed pipe), one or more control valves, one or more flow meters, and the like or combinations thereof. The loading system may be located between the container and the customer's application, preferably the container may be in close proximity to a receiving vessel or inlet conduit as described herein, where the receiving vessel or inlet conduit is connected or fluidly connected to the loading system.

The removing may include transferring the pumpable fat system from a piston tanker (or piston tank) via a pump to a temperature-controlled conduit, wherein the temperature-controlled conduit is connected to a port of the piston tanker (or piston tank); dispensing through the temperature-controlled conduit to a receiving vessel or inlet conduit, wherein the receiving vessel or inlet conduit is part of a product manufacturing system. The receiving vessel may be a kettle for preparing a food item as described herein. Typically, transferring the pumpable fat system from the piston tanker may include applying sufficient pressure (e.g., a pressure of about 3 to about 5 psi) to the piston of the piston tanker (or piston tank). Such pressure may be exerted onto the piston by applying air (or other gas such as an inert gas) pressure to the piston, thereby pushing the pumpable fat system out through a port (e.g., a discharge port) and to the loading system as described herein. The pumpable fat system may then be pumped (e.g., via lobe pump, auger pump, or piston pump) to a customer application.

The removing may include transferring the pumpable fat system from a pail, drum, or tote as described herein via a pumping system to a loading system or directly into a receiving vessel or inlet conduit of a product manufacturing system. For example, the pumpable fat system may be removed via pail, drum, or tote unloaders equipped with a piston pump or other suitable pump. Such unloaders are manufactured by Graco and sold under the tradename SaniForce™ (e.g., SaniForce™ drum unloaders and SaniForce™ bin/tote unloaders).

The inventors discovered the pumpable fat system as described herein surprisingly reduces loss of the pumpable fat system during the supply process. Here, the pumpable fat system may be loaded into and removed from the container with minimal loss of product. Without being bound by any particular theory, it is believed that the combination of physical properties described herein (i.e., viscosity, texture, and SFC) of the pumpable fat system aids in reducing loss of the pumpable fat during the supply process. Typically, greater than about 80% by volume of the pumpable fat system can be removed from the container. For example, greater than about 80% by volume, greater than about 85% by volume, greater than about 90% by volume, greater than about 95% by volume, greater than about 99%, about 99.9%, or any range including and/or in between any two of the preceding values of the pumpable fat system can be removed from the container. Preferably, about 90% to about 99.9% by volume of the pumpable fat system can be removed from the container.

The present invention, thus generally described, will be understood more readily by reference to the following examples, which are provided by way of illustration and are not intended to be limiting of the present invention.

### EXAMPLES

Example 1. Pumpable Fat System Samples. Table 1 Provides Pumpable Fat systems as described herein. Samples 1-3 are pumpable fat systems prepared via votation of a first fat component (i.e., palm oil, palm stearin, hydrogenated soybean oil, and/or interesterified palm oil) with a second fat component (i.e., soybean oil or canola oil). Sample 1 also includes an emulsifier (distilled monoglyceride). Sample 4 provides a pumpable fat system having a mixture of edible solid fats (i.e., interesterified palm oil, palm oil, and palm stearin). As shown in Table 1, samples 1-4 provide pumpable fat systems having a viscosity of 10,000-50,000 cP (Sample 2) or 500,000-1,000,000 cP (samples 1, 3, and 4). Additionally, each of samples 1-4 exhibited a texture of 100-300 G force/cm and a SFC of 4-12 wt %.

| | | Second Fat | | Viscosity (cP) | Texture | SFC |
|---|---|---|---|---|---|---|
| Sample | First Fat Component | Component | Emulsifier | @ 77° F.(25° C.) | (G force/cm) | (wt %) |
| 1 | Palm oil (79.6 wt %) | Soybean Oil | Distilled monoglyce | 500,000-1,0000,000 | 100-300 | 6-10 |
| | | (20 wt %) | ride (0.4 wt %) | | | |
| 2 | Palm Oil (14 wt %) | Canola Oil | — | 10,000-50,000 | 100-300 | 4-8 |
| | Palm Stearin (10 wt %) | (76 wt %) | | | | |
| 3 | Hydrogenated soybean | Soybean Oil | — | 500,000-1,0000,000 | 100-300 | 5-10 |
| | oil (20 wt %) | (80 wt %) | | | | |
| 4 | Interesterified Palm | — | — | 500,000-1,0000,000 | 100-300 | 6-12 |
| | Oil (10 wt %) | | | | | |
| | Palm Oil (85 wt %) | | | | | |
| | Palm Stearin (5 wt %) | | | | | |

### Exemplary Aspects

The following exemplary aspects are provided in the paragraphs below, the numbering of which is not to be construed as designating levels of importance:

Para. A. A pumpable fat system comprising:
about 1.0 weight percent (“wt %”) to 100 wt % of a first fat component comprising a solid fat content (“SFC”) of at least 1.0 wt %, based on total weight of the pumpable fat system; and
optionally, a second fat component;
wherein the pumpable fat system has the following properties at a temperature of about 60° F. to about 85° F.:
   a SFC of about 1.0 wt % to about 20 wt % based on total weight of the pumpable fat system;
   a viscosity of up to about 2,000,000 cP; and
   a texture of 500 G force/cm or less.

Para. B. The pumpable fat system of Para A comprising about 10 wt % to 100 wt % of the first fat component.

Para. C. The pumpable fat system of Paras. A or B comprising about 60 wt % to about 90 wt % of the first fat component.

Para. D. The pumpable fat system of any one of Paras. A-C, wherein the first fat component comprises a natural fat, modified fat, or mixtures thereof.

Para. E. The pumpable fat system of any one of Paras. A-D, wherein the modified edible fat comprises an interesterified fat, a hydrogenated fat, a fractionated fat, or mixtures thereof.

Para. F. The pumpable fat system of any one of Paras. A-E comprising the second fat component, wherein the second fat component is an edible oil.

Para. G. The pumpable fat system of any one of Paras. A-F, wherein the pumpable fat system comprises 0 wt % to about 90 wt % of the second fat component based on total weight of the pumpable fat system.

Para. H. The pumpable fat system of any one of Paras. A-G, wherein the pumpable fat system comprises about 5 wt % to about 50 wt % of the second fat component.

Para. I. The pumpable fat system of any one of Paras. A-H, wherein the pumpable fat system comprises about 10 wt % to about 35 wt % of the second fat component.

Para. J. The pumpable fat system of any one of Paras. A-I, wherein the second fat component comprises a natural edible oil, modified edible oil, or mixtures thereof.

Para. K. The pumpable fat system of Para. J, wherein the modified edible oil comprises an interesterified edible oil, a hydrogenated edible oil, a fractionated edible oil, or mixtures thereof.

Para. L. The pumpable fat system of any one of Paras. A-K, wherein the pumpable fat system has a SFC of about 5.0 wt % to about 20 wt % at a temperature of about 60° F. to about 85° F.

Para. M. The pumpable fat system of any one of Paras. A-L, wherein the pumpable fat system has a SFC of about 5.0 wt % to about 18 wt %.

Para. N. The pumpable fat system of any one of Paras. A-M, wherein the viscosity is about 100,000 cP to less than about 2,000,000 cP.

Para. O. The pumpable fat system of any one of Paras. A-N, wherein the viscosity is about 350,000 cP to about 750,000 cP.

Para. P. The pumpable fat system of any one of Paras. A-O, wherein the texture is 0 G force/cm to less than about 500 G force/cm.

Para. Q. The pumpable fat system of any one of Paras. A-P, wherein the texture is 0 G force/cm to about 125 G force/cm.

Para. R. The pumpable fat system of any one of Paras. A-Q, wherein the texture is about 90 G force/cm to about 325 G force/cm.

Para. S. The pumpable fat system of any one of Paras. A-R, wherein the texture is about 180 G force/cm to about 425 G force/cm.

Para. T. The pumpable fat system of any one of Paras A-S, wherein the pumpable fat system comprises fat crystals having a crystal size of about 3 μm to about 100 μm.

Para. U. The pumpable fat system of any one of Paras. A-T, wherein the pumpable fat system comprises fat crystals having a crystal size of about 20 μm to about 80 μm.

Para. V. A composition comprising about 0.1 wt % to 100 wt % of a pumpable fat system according to any one of Paras. A-U.

Para. W. A method of supplying a pumpable fat system according to any one of Paras. A-U, the method comprising:
loading the pumpable fat system into a container;
transporting the container containing the pumpable fat system; and
removing the pumpable fat system from the container;
wherein the pumpable fat system is maintained at a temperature of about 60° F. to about 85° F.

Para. X. The method of Para. W, wherein the temperature is about 70° F. to about 85° F.

Para. Y. The method of Para. W or X, wherein the temperature is about 75° F. to about 85° F.

Para. Z. The method of any one of Paras. W-Y, wherein the container comprises a pail, a drum, a tote, a piston tanker, or combinations thereof.

Para. AA. The method of any one of Paras. W-Z, wherein the container is a temperature-controlled container.

Para. AB. The method of any one of Paras. W-AA, wherein the loading comprises transferring the pumpable fat system from a feed source through a temperature-controlled conduit to the container.

Para. AC. The method of any one of Paras. W-AB further comprising recycling the pumpable fat system back to the feed source.

Para. AD. The method of any one of Paras. W-AC further comprising recycling residual amounts of the pumpable fat system back to the feed source.

Para. AE. The method of any one of Paras. W-AD further comprising storing the pumpable fat system in the container.

Para. AF. The method of any one of Paras. W-AE, wherein the storing occurs over a period of about 1 hour to about 4 weeks.

Para. AG. The method of any one of Paras. W-AF, wherein the storing occurs at a temperature of about 60° F. to about 85° F.

Para. AH. The method of any one of Paras. W-AG, wherein removing the pumpable fat system from the container is performed with a pump.

Para. AI. The method of any one of Paras. W-AH, wherein the pump is a lobe pump, piston pump, gear pump, Moyno pump, auger pump, or combinations thereof.

Para. AJ. The method of any one of Paras. W-AI, wherein greater than about 80% by volume of the pumpable fat system is removed from the container.

Para. AK. The method of any one of Paras. W-AJ, wherein greater than about 90% by volume of the pumpable fat system is removed from the container.

Para. AL. The method of any one of Paras. W-AK, wherein about 99.9% by volume of the pumpable fat system is removed from the container.

Para. AM. The method of any one of Paras. W-AL, wherein the removing comprises unloading the pumpable fat system from the container to a product manufacturing system.

Para. AN. The method of any one of Paras. W-AM, wherein the product manufacturing system is a food item production system.

Each of the non-limiting aspects above can stand on its own or can be combined in various permutations or combinations with one or more of the other aspects or other subject matter described in this document. While the invention has been illustrated and described in certain aspects, a person with ordinary skill in the art, after reading the foregoing specification can effect changes, substitutions of equivalents and other types of alterations to the present technology as set forth herein. Each aspect described above can also have included or incorporated therewith such variations or aspects as disclosed in regard to any or all of the other aspects.

The present technology is also not to be limited in terms of the particular aspects described herein, which are intended as single illustrations. Many modifications and variations of this present technology can be made without departing from its spirit and scope, as will be apparent to those skilled in the art from the foregoing descriptions. Such modifications and variations are intended to fall within the scope of the appended claims. It is to be understood that this present technology is not limited to particular methods, reagents, compounds, or compositions, which can, of course, vary. It is also to be understood that the terminology used herein is for the purpose of describing particular aspects only and is not intended to be limiting. Thus, it is intended that the specification be considered as exemplary only with the breadth, scope and spirit of the present technology indicated only by the appended claims, definitions therein and any equivalents thereof.

The aspects, illustratively described herein may suitably be practiced in the absence of any element or elements, limitation or limitations, not specifically disclosed herein. Thus, for example, the terms “comprising,” “including,” “containing,” etc. shall be read expansively and without limitations. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter form the genus, regardless of whether or not the excised material is specifically.

1. A pumpable fat system comprising:
about 1.0 weight percent (“wt %”) to 100 wt % of a first fat component comprising a solid fat content (“SFC”) of at least 1.0 wt %, based on total weight of the pumpable fat system; and
optionally, a second fat component;
wherein the pumpable fat system has the following properties at a temperature of about 60° F. to about 85° F.:
a SFC of about 1.0 wt % to about 20 wt % based on total weight of the pumpable fat system;
a viscosity of up to about 2,000,000 cP; and
a texture of 500 G force/cm or less.

2. The pumpable fat system of claim 1 comprising about 10 wt % to 100 wt % of the first fat component.

3. The pumpable fat system of claim 1, wherein the first fat component comprises a natural fat, modified fat, or mixtures thereof.

4. The pumpable fat system of claim 3, wherein the modified edible fat comprises an interesterified fat, a hydrogenated fat, a fractionated fat, or mixtures thereof.

5. The pumpable fat system of claim 1 comprising the second fat component, wherein the second fat component is an edible oil.

6. The pumpable fat system of claim 1, wherein the pumpable fat system comprises 0 wt % to about 90 wt % of the second fat component based on total weight of the pumpable fat system.

7. The pumpable fat system of claim 1, wherein the pumpable fat system has a SFC of about 5.0 wt % to about 20 wt % at a temperature of about 60° F. to about 85° F.

8. The pumpable fat system of claim 1, wherein the viscosity is about 100,000 cP to less than about 2,000,000 cP.

9. The pumpable fat system of claim 1, wherein the texture is 0 G force/cm to less than about 500 G force/cm.

10. The pumpable fat system of claim 1, wherein the pumpable fat system comprises fat crystals having a crystal size of about 3 μm to about 100 μm.

11. A composition comprising about 0.1 wt % to 100 wt % of a pumpable fat system according to claim 1.

12. A method of supplying a pumpable fat system according claim 1, the method comprising:
loading the pumpable fat system into a container;
transporting the container containing the pumpable fat system; and
removing the pumpable fat system from the container;
wherein the pumpable fat system is maintained at a temperature of about 60° F. to about 85° F.

13. The method of claim 12, wherein the temperature is about 70° F. to about 85° F.

14. The method of claim 12, wherein the container comprises a pail, a drum, a tote, a piston tanker, or combinations thereof.

15. The method of claim 12, wherein the container is a temperature-controlled container.

16. The method of claim 12, wherein the loading comprises transferring the pumpable fat system from a feed source through a temperature-controlled conduit to the container.

17. The method of claim 12 further comprising storing the pumpable fat system in the container.

18. The method of claim 12, wherein removing the pumpable fat system from the container is performed with a pump.

19. The method of claim 12, wherein greater than about 80% by volume of the pumpable fat system is removed from the container.

20. The method of claim 12, wherein the removing comprises unloading the pumpable fat system from the container to a product manufacturing system.
